(19) United States
(12) Patent Application Publication
(10) Pub. No.: US 2015/0207114 A1
(43) Pub. Date: Jul. 23, 2015

(54) POUCH CELL HOUSING

(71) Applicant: Maxwell Technologies, Inc., San Diego, CA (US)

(72) Inventors: Alexander Khakhalev, Troy, MI (US); Laurent Gisler, Belfaux (CH); Martin Angeloz, Nierlet-les-Bois (CH)

(21) Appl. No.: 14/599,949

(22) Filed: Jan. 19, 2015

Related U.S. Application Data
(60) Provisional application No. 61/929,260, filed on Jan. 20, 2014.

(51) Int. Cl. H01M 2/02; H01G 11/84; H01G 11/78

(52) U.S. Cl. CPC H01M 2/0287; H01M 2/02; H01G 11/78; H01G 11/84

(57) ABSTRACT

An energy storage device housing may include a first housing shell portion having a first protrusion on an internal surface of the first housing shell portion. The energy storage device may include a second opposing housing shell portion bonded to at least a portion of the first protrusion. The energy storage device may include an energy storage device component stack having an opening shaped and/or dimensioned to facilitate contact between the first protrusion and the second housing shell portion. A method of forming an energy storage device housing may include forming a first protrusion on a first surface of a first housing shell portion, the first surface being lined with a first polymer. The method may include heating the first protrusion on the first surface of the first housing shell portion to form an opening in the first polymer adjacent to the first protrusion such that the first protrusion extends through the opening.

### REFERENCE TO RELATED APPLICATIONS

Any and all applications for which a foreign or domestic priority claim is identified in the Application Data Sheet as filed with the present application are hereby incorporated by reference under 37 CFR 1.57.

### BACKGROUND

1. Field

The present invention relates generally to electrical energy storage devices, and more specifically, to the design of the energy storage device housing and components of the energy storage device housed within the housing.

2. Description of the Related Art

Energy storage devices may be housed in a pouch cell housing, including a prismatic pouch cell housing. Prismatic pouch cell housings generally can include a rectangular or substantially rectangular outer housing having one or more edges being sealed together, for example through a thermal seal process. A prismatic pouch cell housing may include a positive electrode contact to couple to a positive electrode of the energy storage device and/or a negative electrode contact to couple to a negative electrode extending from an edge of the housing to a connection point. Use of a prismatic pouch cell housing can allow energy storage devices to have a thin profile and/or allow tailoring of the energy storage devices to desired dimensions (e.g., a thickness, a length, and/or a width) for specific applications.

Prismatic pouch cells may facilitate packaging efficiency, allowing efficient use of available space within the energy storage device housing. Prismatic pouch cell housings can be used in various types of energy storage devices, including ultracapacitors (e.g., electric double-layer capacitors, pseudo-capacitors, hybrid capacitors) and/or batteries. Ultracapacitors and/or batteries having a prismatic pouch cell housing may be used in a wide range of electronic devices, including mobile phones, cameras, solid state drives, and/or computer tablets.

### SUMMARY

An energy storage device housing can include a first housing shell portion having a first protrusion on an internal surface of the first housing shell portion, and a second opposing housing shell portion bonded to at least a portion of the first protrusion. At least one of the first housing shell portion and the second opposing housing shell portion may include a stainless steel sheet.

In some embodiments, the second opposing housing shell portion can include a second protrusion on an internal surface of the second opposing housing shell portion. The first protrusion may be on substantially a center of the first housing shell portion and the second protrusion may be on substantially a center of the second opposing housing shell portion. In some embodiments, the second protrusion can include a distal tip portion, where the distal tip portion of the second protrusion can be bonded to the internal surface of the first housing shell portion. In some embodiments, the distal tip portion of the second protrusion can be bonded to a distal tip portion of the first protrusion.

In some embodiments, the energy storage device can include a first polymer lining the internal surface of the first housing shell portion and a second polymer lining the internal surface of the second opposing housing shell portion, where a continuous internal lining including the first polymer and the second polymer substantially seals a content of the energy storage device housing.

In some embodiments, the energy storage device can include an energy storage device component stack including an opening extending through an entire thickness of the energy storage device component stack, where at least a portion of the first protrusion extends into the opening of the energy storage device component stack. The energy storage device component stack may include a plurality of energy storage device electrodes and at least one energy storage device separator.

In some embodiments, the second opposing housing shell portion can include a second protrusion on an internal surface of the second opposing housing shell portion, where both at least a portion of the first protrusion and at least a portion of the second protrusion extend into the opening in the energy storage device component stack, and where the first protrusion and the second protrusion are bonded to one another within the opening in the energy storage device component stack.

In some embodiments, the opening in the energy storage device component stack has a similar shape as a shape of the portion of the first protrusion or a shape of the portion of the second protrusion.

In some embodiments, the energy storage device can include a first polymer lining the internal surface of the first housing shell portion and a second polymer lining the internal surface of the second opposing housing shell portion, and where the opening in the energy storage device component stack has a dimension configured to accommodate the first polymer and the second polymer.

A method of forming an energy storage device housing can include forming a first protrusion on a first surface of a first housing shell portion, the first surface being lined with a first polymer, and heating the first protrusion on the first surface of the first housing shell portion to form an opening in the first polymer adjacent to the first protrusion such that the first protrusion extends through the opening in the first polymer.

In some embodiments, the method can include bonding a second opposing housing shell portion to the first surface of the first housing shell portion. A second protrusion may be formed on a first surface of the second opposing housing shell portion, the first surface of the second opposing housing shell portion being lined with a second polymer. In some embodiments, at least one of the first polymer and the second polymer can consist essentially of polypropylene.

In some embodiments, the method can include heating the second protrusion to form an opening in the second polymer adjacent to the second protrusion such that the second protrusion extends through the opening in the first polymer. Heating the first protrusion can include heating a distal tip portion of the first protrusion and heating the second protrusion can include heating a distal tip portion of the second protrusion. In some embodiments, heating can include applying a laser heat source. The laser heat source may be configured to provide an electromagnetic radiation having a wavelength less than 10 microns.

In some embodiments, bonding the second opposing housing shell portion to the first surface of the first housing shell portion can include bonding the distal tip portion of the first protrusion to the distal tip portion of the second protrusion. The bonding may include forming an internal housing lining within the energy storage device housing, the internal housing lining including the first polymer and the second polymer. In some embodiments, the bonding can be achieved by using at least one of laser welding and resistance welding.

In some embodiments, the method can include forming an opening in one or more energy storage device component stacks for facilitating contact between the first protrusion and the second opposing housing shell portion, the opening having a dimension configured to accommodate at least a portion of the first protrusion.

In some embodiments, the method can include placing the energy storage device component stack on the first housing shell portion, the distal tip portion of the first protrusion extending into the opening in the energy storage device component stack.

In some embodiments, the method can include placing the second opposing housing shell portion on the energy storage device component stack, the distal tip portion of the second protrusion extending into the opening in the energy storage device component stack and contacting the distal tip portion of the first protrusion within the opening.

For purposes of summarizing the invention and the advantages achieved over the prior art, certain objects and advantages are described herein. Of course, it is to be understood that not necessarily all such objects or advantages need to be achieved in accordance with any particular embodiment. Thus, for example, those skilled in the art will recognize that the invention may be embodied or carried out in a manner that can achieve or optimize one advantage or a group of advantages without necessarily achieving other objects or advantages.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

FIG. 1 shows an isometric view of an example energy storage device having a pouch cell housing.

FIG. 2A shows a side cross-sectional view of an example shell portion of a pouch cell housing.

FIG. 2B shows a side cross-sectional view of an example shell portion of a pouch cell housing having a protrusion on a first surface of the shell portion.

FIG. 2C shows a side cross-sectional view of an example shell portion of a pouch cell housing, where openings are formed in polymer layers lining opposing surfaces of the shell portion.

FIG. 3 is an isometric view of an example protrusion on an example pouch cell housing shell portion.

FIG. 4 shows a side cross-sectional view of an example profile of a protrusion which may be formed on a pouch cell housing shell portion.

FIG. 5 shows a side cross-sectional view of a pouch cell housing having a first protrusion on a first shell portion and a corresponding second protrusion on a second shell portion.

FIG. 6A shows a side cross-sectional view of an example of a first protrusion on a first shell portion of a pouch cell housing bonded to a corresponding second protrusion on a second shell portion.

FIG. 6B shows a side cross-sectional view of another example of a first protrusion on a first shell portion of a pouch cell housing bonded to a corresponding second protrusion on a second shell portion.

FIG. 7A shows a side cross-sectional view of an example protrusion on a pouch cell housing shell portion.

FIG. 7B shows a side cross-sectional view of an example protrusion in an off-set configuration on a prismatic pouch cell housing shell portion.

FIG. 8 shows an example process of forming a pouch cell housing.

FIG. 9 shows an example energy storage device component stack which can be housed within a pouch cell housing.

FIG. 10 shows an example process of forming an energy storage device including a pouch cell housing enclosing an energy storage device component stack.

FIG. 11 is a simulation showing a deformation of a pouch cell housing with no protrusions formed on any of the pouch cell shell portions.

FIG. 12 is a simulation showing a deformation of a pouch cell having a protrusion formed on a shell portion of the pouch cell.

### DETAILED DESCRIPTION

Although certain embodiments and examples are described below, those of skill in the art will appreciate that the invention extends beyond the specifically disclosed embodiments and/or uses and obvious modifications and equivalents thereof. Thus, it is intended that the scope of the invention herein disclosed should not be limited by any particular embodiments described below.

A pouch cell housing, including a prismatic pouch cell housing, may be vulnerable to deformation in the course of its use. The pouch cell housing of an energy storage device may become deformed due to a build-up of gas generated by electrochemical reactions and/or vaporization of components within the energy storage device. Gaseous by-products may be generated during a charge and/or a discharge of the energy storage device, resulting in, for example, swelling of the pouch cell housing. Gaseous by-products generated by the energy storage device which can contribute to pressure build-up within the energy storage device housing can include, for example, hydrogen (H₂), carbon monoxide (CO), and/or carbon dioxide (CO₂). Deformation of the energy storage device housing, such as a bulging of the energy storage device, may negatively impair a performance of the energy storage device and/or an integrity of an energy storage device component, contributing for example to an electrical failure of the energy storage device.

Embodiments relate to a housing for an electronic energy storage device with an attachment point that links two sides of the electronic energy device housing together. For example, one embodiment is a pouch cell housing, including a prismatic pouch cell housing, that includes one or more dimples, or indents, which can be used to fuse two sides of the housing together. In this embodiment, a dimple may be located at the approximate center of the device. By fusing the two sides of the device housing together at the approximate center point, the device can better withstand any pressure build up from internally released gases. In one embodiment, the dimples are formed by first indenting each side of the device. In many devices, the interior sides of an electronic energy storage device, such as an ultracapacitor, are lined with a polymeric material to prevent the electrolyte from reacting with the metal housing of the device. For example, interior sides of the electronic energy storage device may be coated with a polypropylene material. By indenting the device, the interior surface lining can become weakened and stretched over the inner portion of the indent. Application of the proper amount of heat, such as from a laser, can then be used to quickly melt the interior surface coating at its stretch point, for example so that its own elasticity forces the interior layer to recede down the interior surface of the indent and become an elevated donut-shaped ring at the bottom of the indent on the interior surface as the receding coating rolls back upon itself. The interior metal of the indent can then be exposed to be welded to a similar indent on an opposing side of the electronic energy storage device housing, and the elevated donut-shaped ring made of the interior surface coating can contact a similar donut-shaped ring on the opposing of the device housing and provide a circumferential barrier that prevents electrolyte from contacting the bare weld at the interior of the device.

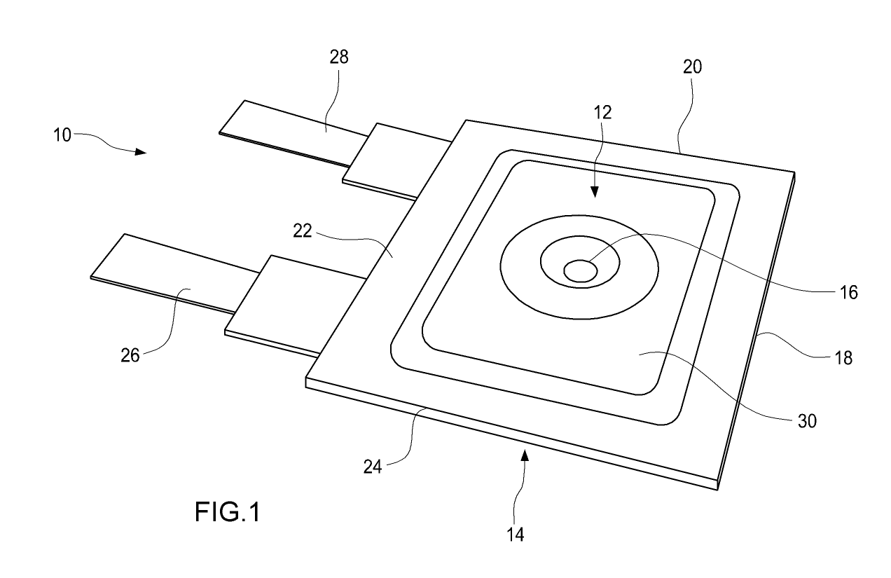

FIG. 1 shows an isometric view of an example energy storage device with a pouch cell housing 10. The pouch cell housing 10 may include an upper shell portion 12 and a lower shell portion 14. As shown in FIG. 1, the pouch cell housing 10 may have a prismatic shape, for example comprising a prismatic pouch cell housing. Components of one or more energy storage cells may be housed within the pouch cell housing 10, such as components of one or more ultracapacitor cells, and/or one or more battery cells, or other energy storage device cells. The pouch cell housing 10 may include a feature to provide the pouch cell housing 10 with desired mechanical strength, for example to facilitate reduced deformation of the pouch cell housing 10 during operation of the one or more energy storage cells housed within the pouch cell housing 10. The feature may comprise a depression 16 (e.g., a dimple) extending into an exterior surface 30 of the pouch cell housing 10. In some embodiments, the pouch cell housing 10 may have a protrusion (not shown) corresponding to the depression 16, and extending from an interior surface of the housing 10. The one or more depressions 16 may facilitate a reduction in a swelling of the pouch cell housing 10 resulting from pressure exerted upon the pouch cell housing 10 by gaseous by-products generated within the pouch cell housing 10 during the operation of the one or more energy storage cells. For example, the protrusion on the interior surface of the upper shell portion 12, which corresponds to the depression 16 on the exterior surface 30 of the upper shell portion 12, can attach to the lower shell portion 14, thereby providing a pouch cell housing 10 with increased mechanical strength. The pouch cell housing 10 having increased mechanical strength may exhibit reduced outward expansion due to pressure exerted upon the housing 10 by gaseous byproducts generated during a charge and/or a discharge of one or more energy storage cells within the housing 10.

FIG. 1 shows that, in one embodiment, the depression 16 may have a tapered profile. In one embodiment, the depression 16 can have a circular or substantially circular shape. For example, the depression 16 can have a truncated conical shape. In some embodiments, the depression 16 may not have a circular shape. As shown in FIG. 1, the depression 16 may be centered or substantially centered on the outer surface 30 of the first shell portion 12. In some embodiments, the depression 16 may not be centered on the outer surface 30 of the first shell portion 12.

The pouch cell housing 10 may have a plurality of depressions on one or more exterior surfaces of the pouch cell housing 10. For example, a pouch cell housing 10 may include a plurality of depressions on one or more exterior surfaces, where the plurality of depressions may have a shape, a dimension (e.g., a length, a diameter, a height, and/or a degree of taper), and/or pattern of distribution on the one or more exterior surfaces configured to provide a desired reduction in the swelling of the pouch cell housing 10.

The upper shell portion 12 and the lower shell portion 14 of the pouch cell housing 10 are shown as having a rectangular or substantially rectangular shape. In some embodiments, the pouch cell housing 10 can have four straight or substantially straight edges 18, 20, 22 and 24. Referring to FIG. 1, the upper shell portion 12 may be attached to the lower shell portion 14 along each of their respective edges to form the edges 18, 20, 22, and 24 of the pouch cell housing 10. In some embodiments, the upper shell portion 12 and/or the lower shell portion 14 of the pouch cell housing 10 can comprise a thermally conductive material. The upper shell portion 12 and/or the lower shell portion 14 may comprise a material which can provide sufficient mechanical protection for the energy storage device while providing a degree of elasticity to allow a deformation of the pouch cell housing 10 in response to pressure exerted by gaseous by-products generated during the operation of the energy storage device. For example, the upper shell portion 12 and/or the lower shell portion 14 can comprise a metallic material, including a stainless steel material, an aluminum material, combinations thereof, and/or the like.

In some embodiments, an edge portion of the pouch cell housing 10, such as edge portion 18, may be formed by laminating together an edge portion of the upper shell portion 12 and a corresponding edge portion of lower shell portion 14. In some embodiments, an edge portion of the upper shell portion 12 and a corresponding edge portion of lower shell portion 14 may be attached through a welding process. For example, an ultrasonic welding technique, a resistance welding technique and/or an energy beam welding technique (e.g., using a laser beam and/or an electron beam) may be applied. Other suitable methods of attachment may also be possible.

In some embodiments, the pouch cell housing 10 can be coupled to a positive electrode contact 26 and a negative electrode contact 28, the electrode contacts configured to make electrical contact with one or more energy storage device electrodes housed within the pouch cell housing 10. In some embodiments, an electrode contact may be coupled to an edge portion of a pouch cell housing 10. Referring to FIG. 1, the positive electrode contact 26 and the negative electrode contact 28 may be attached to an edge portion of the pouch cell housing 10, such as edge portion 22. The positive electrode contact 26 and/or the negative electrode contact 28 can comprise an electrically conductive material. A suitable material for the electrode contacts may include a metallic material, including but not limited to, aluminum, copper, silver, gold, platinum, palladium, alloys thereof, and/or the like. The positive electrode contact 26 and negative electrode contact 28 may be electrically insulated from each other and from the housing 10. For example, an electrically insulating sleeve may surround a least a portion of the positive electrode contact 26 and the negative electrode contact 28 to electrically insulate the electrode contacts from one another and from the housing 10. The positive contact 26 and/or the negative electrode contact 28 may have any shape and/or dimension (e.g., a length, a width, and/or a thickness) suitable to provide sufficient contact between the positive and/or negative electrodes of the energy storage device (within the housing 10) and an external circuit, respectively. For example, the positive electrode contact 26 and the negative electrode contact 28 may include a metallic foil having a rectangular or substantially rectangular shape.

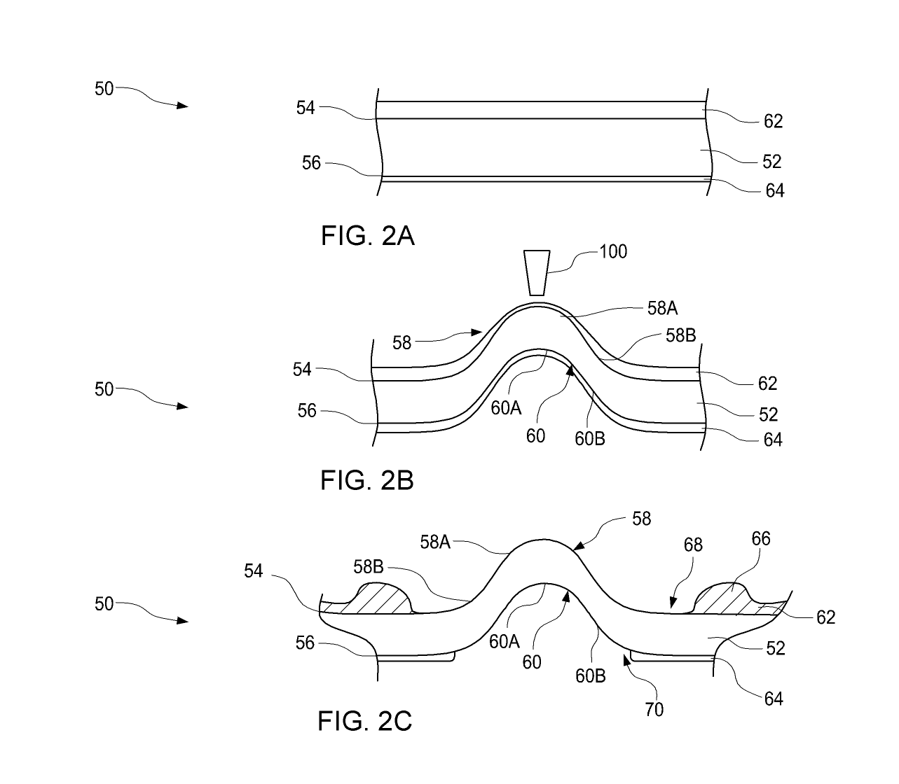

FIGS. 2A-2C show side cross-sectional views of one embodiment of a process for making a dimpled shell of a pouch shell housing for an energy storage device, including the pouch cell housing 10 shown in FIG. 1. Referring to FIG. 2A, a first shell portion 50 is shown which could make up an upper shell portion 12 or lower shell portion 14 of the pouch cell housing shown in FIG. 1. The first shell portion 50 has a shell layer 52 with an inner surface 54 and an outer surface 56. In some embodiments, the inner surface 54 can be a surface on an interior of a pouch cell housing, and the outer surface 56 can be a surface on an exterior of the pouch cell housing.

The first shell portion 50 has a first polymer layer 62 adjacent to the inner surface 54 and a second polymer layer 64 adjacent to the outer surface 56. The first polymer layer 62 may comprise a material which can be thermally and/or chemically stable during an operation of the energy storage device. For example, the first polymer layer 62 may comprise a material which can be thermally and/or chemically stable when exposed to an electrolyte of the energy storage device under one or more operating conditions of the energy storage device. In some embodiments, the first polymer layer 62 can include a polypropylene. In some embodiments, the second polymer layer 64 may comprise a polyamide (e.g., nylon).

A binder material or adhesive material (not shown) can be applied to the inner surface 54 and/or the outer surface 56 to facilitate adhesion of a polymer layer (e.g., the first polymer layer 62 and/or the second polymer layer 64) to the respective surfaces. For example, one or more binder or adhesive material layers can be applied to each of the inner surface 54 and/or the outer surface 56. A binder or adhesive layer may have a thickness of less than about 5 microns, for example about 1 micron. The binder or adhesive material can comprise a variety of suitable materials, including but not limited to a material which can be thermally and/or chemically stable during operation of the energy storage device. In some embodiments, the binder or adhesive may be a polymeric material.

FIG. 2B shows a first protrusion 58 which may be formed in the first shell portion 50. The first protrusion 58 may have a dimension (e.g., a height, a length, and/or a width), a shape, and/or a profile which depends on a thickness of the pouch cell housing. As shown, the first protrusion 58 has a first protrusion tip portion 58A and a base portion 58B that would be on the interior of a pouch cell. In some embodiments, the first protrusion 58 may have a tapered profile, for example a linearly or substantially linearly tapered profile, including a cylindrical or substantially cylindrical shape, and/or a conical or substantially conical shape.

In some embodiments, the first protrusion 58 can have a non-linear taper (e.g., a curvilinear profile having one or more curved portions, such as a profile having an “s” shape), including a half-dome shape. In some embodiments, the first protrusion base portion 58B can have an oval shape, a rectangular shape, and/or another prismatic shape. For example, the first protrusion 58 may have a dimension, a shape, and/or a profile configured to provide desired reduction of a swelling in the pouch cell housing. In some embodiments, one or more energy storage device components (e.g., energy storage device electrodes and/or separators) housed within the pouch cell housing may have an opening which corresponds to the first protrusion 58, for example to facilitate contact between the first protrusion 58 and a corresponding protrusion on an opposing shell layer of the housing. For example, a dimension of the first protrusion 58 (e.g., a cross-sectional width) may be less than a dimension (e.g., a width) of the one or more electrodes. Further details regarding suitable configurations for one or more energy storage device components are described herein.

The outer surface 56 can have a first depression 60 corresponding to the first protrusion 58, the first depression 60 having a first depression tip portion 60A and a first depression base portion 60B. The first depression 60 may have a shape, dimension and/or profile which correspond to the shape, dimension and/or profile, respectively, of the first protrusion 58. For example, the protrusion 58 can have a conical or substantially conical shape, and the depression 60 can have a corresponding conical or substantially conical shape. Other combinations may also be possible.

The first polymer layer 62 may be stretched by the formation of the first protrusion 58 in the first shell portion 50, for example stretching the portion of the first polymer layer 62 proximate or adjacent to the first protrusion tip portion 58A. Stretching of the first polymer layer 62 can result in thinning of the first polymer layer 62 proximate or adjacent to the first protrusion tip portion 58A. Sometimes the first polymer layer 62 can be thinned to the point it breaks, forming a first opening (e.g., a first opening 68 as shown in FIG. 2C) in the portion of the first polymer layer 62 over the first protrusion 58, such as in the portion of the first polymer layer 62 proximate or adjacent to the first protrusion 58. A degree to which the first polymer layer 62 adjacent to the first tip portion 58A can be thinned may depend on a characteristic of the first polymer layer 62 (e.g., a polymer thickness and/or a polymer composition) and/or a characteristic of the first protrusion 58 (e.g., a shape, a dimension and/or a profile of the first protrusion 58). In some embodiments, a thickness of the first polymer layer 62 adjacent to the first protrusion tip portion 58A can be thinned by about 20% to about 80%. For example, a first polymer layer 62 comprising polypropylene adjacent to the first protrusion tip portion 58A may be stretched, thinning a thickness of the first polymer layer 62 by about 40% to about 60%, including by about 50%.

As shown in FIG. 2B, in an example process for forming the first opening in the first polymer layer 62, a heat source 100 can be applied to the first protrusion 58. For example, the heat source 100 may be directed to the first protrusion tip portion 58A to facilitate the creation of the first opening (e.g., a first opening 68 as shown in FIG. 2C) in the portion of the first polymer layer 62 proximate or adjacent to the tip portion 58A. In some embodiments, the first polymer layer 62 is transparent to the heat source 100. For example, a suitable heat source 100 may be directed at a portion of the first shell layer 52 (e.g., a first protrusion tip portion 58A of the first shell layer 52) to directly heat the first shell layer 52. A rise in the temperature of the first shell layer 52 can in turn raise the temperature of the first polymer layer 62 proximate or adjacent to the portion of the first shell layer 52 being warmed by the heat source 100. For example, the first polymer layer 62 can be heated through a back-heating process, the heat source 100 not directly heating the first polymer layer 62. In some embodiments, back-heating of the first polymer layer 62 can enable a simplified pouch cell manufacturing process. For example, back-heating the first polymer layer 62 may facilitate forming the opening in the first polymer layer 62 without or substantially without burning the first polymer layer 62, thereby facilitating a fabrication process which does not include a burnt polymer byproduct removal step.

The first depression 60 may stretch a portion of the second polymer layer 64 proximate or adjacent to the first depression 60. For example, the portion of the second polymer layer 64 proximate or adjacent to the first depression 60 may be thinned as the first depression 60 is formed, similar to the above description of the first polymer layer 62. In some embodiments, applying the heat source 100 to the first protrusion tip portion 58A can provide back-heating to the second polymer layer 64 proximate or adjacent to the first depression tip portion 60A, facilitating creation of a second opening (e.g., a second opening 70 as shown in FIG. 2C) in the second polymer layer 64 proximate or adjacent to the first protrusion tip portion 60A. For example, a second polymer layer 64 comprising a polyamide (e.g., nylon) may be stretched in a portion proximate or adjacent to the first depression tip portion 60A, and a second opening proximate or adjacent to the first depression tip portion 60A may be formed in the second polymer layer 64 after applying the heat source 100 to the first protrusion tip portion 58A.

As described herein, in some embodiments, one or more adhesive or binder layers can be applied to each of the inner surface 54 and/or the outer surface 56. The one or more adhesive or binder layers on the inner surface 54 and/or the outer surface 56 may be transparent to the heat source 100 for example not being directly heated by the heat source 100 such that the heat source 100 back-heats the one or more adhesive or binder layers. An opening may be formed in the binder or adhesive layers by directly heating the shell layer 52 (e.g., at a first protrusion tip portion 58A) and back-heating the adhesive or binder layers. For example, the same heating step used to form the one or more openings in the first polymer layer 62 and/or the second polymer layer 64 may form an opening in the corresponding adhesive or binder layers. Back-heating of the one or more adhesive or binder layers may facilitate forming an opening in the one or more adhesive or binder layers without or substantially without burning the one or more adhesive or binder layers.

The heat source 100 may include any heat source suitable for heating the shell layer 52. For example, a suitable heat source 100 may be configured for heating a shell layer 52 comprising a metallic material, such as a stainless steel material, an aluminum material, combinations thereof, and/or the like. The heat source 100 can be configured to provide direct heating to the shell layer 52 while not directly heating the first polymer layer 62, the second polymer layer 64, and the one or more binder or adhesive layers. In some embodiments, the heat source 100 may comprise a laser. In some embodiments, the heat source 100 can include a pulse laser. For example, a variety of laser pulse shapes may be suitable (e.g., a rectangular shape, a step shape, a linear ramp-up, a linear ramp-down, and/or combinations thereof) to implement desired heating of the shell layer 52. Various laser frequencies can be used. In some embodiments, a suitable laser provides electromagnetic radiation which can efficiently heat the shell layer 52 to provide sufficient back-heating to the first polymer layer 62, the second polymer layer 64, and the binder layers, such as electromagnetic radiation having wavelengths less than about 10 microns. For example, a suitable laser may provide electromagnetic radiation having a wavelength of about 1 micron, and/or about 5 microns. In some embodiments, the heat source 100 can include a YAG laser, for example a laser comprising a neodymium-doped yttrium aluminum garnet (e.g., Nd:Y₃Al₅O₁₂, Nd:YAG). Other suitable lasers can also be used.

The heat source 100 may be applied to the first shell layer 52, such as the first tip portion 58A of the first shell layer 52, for a duration sufficient for creating the opening (e.g., to raise a temperature of a portion of the first polymer layer 62 to or above a temperature at which the first polymer layer 62 begins to disintegrate and/or melt) in the portion of the first polymer layer 62 adjacent to the first tip portion 58A. For example, the duration of heating may depend on a characteristic of the heating source 100 (e.g., a type of heating applied, and/or a manner in which the heating is applied), a characteristic of the first polymer layer 62 (e.g., a thickness and/or a type of the polymer material), and/or a characteristic of the shell layer 52 (e.g., an ability of the shell layer 52 to conduct heat from the heating source 100 to the first polymer layer 62). In one embodiment, the heat source 100 may be applied to the first tip portion 58A for about 1 second to about 30 seconds. For example, a heat source 100 comprising a YAG laser may be applied to a first protrusion tip portion 58A of a shell layer 52 comprising stainless steel for a duration of less than about 5 seconds (e.g., about 2 seconds) such that an opening can be formed in the first polymer layer 62 adjacent to the first tip portion 58A, the first polymer layer 62 comprising a polypropylene material.

In some embodiments, a pattern in which heat is applied to a protrusion can facilitate formation of a desired openings in the first polymer layer 62, the second polymer layer 64, and/or in the adhesive or binder layers. For example, a pattern of heating applied to a protrusion may facilitate desired back-heating of the layers, forming the openings in one or more of the first polymer layer 62, the second polymer layer 64, and in the adhesive or binder layer without or substantially without burning the one or more layers while facilitating a sustained pull-back of the one or more of the layers (e.g., the first polymer layer 62). In some embodiments, a heat source 100 may be initially applied to a center portion of the first protrusion tip portion 58A. The heat source 100 may subsequently be directed outward from the center portion, including for example being directed outward from the center portion in an outward spiral motion. In some embodiments, the heat source 100 may be directed outward from the center portion of the first protrusion tip portion 58A in a controlled manner. For example, the pattern in which the heat source 100 is directed at the protrusion 58A may include an outward motion in a gradual spiral pattern. Other patterns of heating the first protrusion 58 may also be suitable. In some embodiments, the shell layer 52 can be moved with respect to the heat source 100 to provide a desired heating pattern.

As shown in FIG. 2C, a first opening 68 can be formed in the first polymer layer 62 around and thus adjacent to the first protrusion 58. A second opening 70 can be formed in the second polymer layer 64 around and thus adjacent to the first depression 60. The elasticity of the first polymer layer 62 can force the portion of the first polymer layer 62 adjacent to the first protrusion 58 to fold back, upon itself, down the inner surface of the first shell layer 52, forming a polymer ring 66 around a portion of the first protrusion base portion 58B, thereby exposing the inner surface 54 of the first shell layer 52 at the first protrusion tip portion 58A. In some embodiments, the exposed inner surface 54 at the first protrusion tip portion 58A can be welded to a similar protrusion tip portion on an opposing shell layer of the pouch cell housing.

In some embodiments, the polymer ring 66 has an increased thickness as compared to other portions of the first polymer layer 62. For example, the polymer ring 66 may comprise an elevated donut-shaped ring around the first protrusion base portion 58B.

In some embodiments, the first polymer ring 66 may have a parameter (e.g., a profile, a height and/or a width) which depends on a characteristic of the first polymer layer 62 (e.g., a thickness, and/or a composition of the first polymer layer 62), and/or a characteristic of the first protrusion 58 (e.g., a height, a length, a diameter, a width, a profile, and/or a shape of the first protrusion). The elevated polymer ring 66 in the first polymer layer 62 can contact a similar elevated polymer ring on an opposing shell layer of the pouch cell housing, thereby providing a circumferential polymeric barrier which can prevent a device electrolyte from contacting the bare weld formed between exposed protrusions of opposing shell layers at the interior of the pouch cell housing.

Formation of one or more openings in a first polymer layer adjacent an inner surface and/or a second polymer layer adjacent an outer surface of a pouch cell housing shell layer by directly heating the shell layer while back-heating the first and/or second polymer layers can facilitate removal of the first and/or the second polymer layers from a portion of the shell layer without a chemical process (e.g., use of chemical compounds in removing the polymer layer at designated locations), and/or a mechanical process (e.g., mechanical scratching of the polymer layer to remove the polymer at designated locations), which can generate by-products requiring additional disposal processes (e.g., disposal of chemical compounds used and/or polymer by-products generated in the removal process). Formation of the one or more openings in the first and/or the second polymer layers by back-heating the polymer layers may facilitate a simpler energy storage device fabrication process, providing an energy storage device which can be cheaper to manufacture.

In some embodiments, a shell portion 50 can include more than one protrusion 58 on an inner surface 54 of the shell layer 52. For example, a shell portion 50 can include a plurality of protrusions to facilitate desired reduction in swelling of the pouch cell housing. A number and/or a pattern of distribution of the first protrusions 58 on the inner surface 54 of the shell layer 52 may depend on one or more design parameters of the pouch cell housing and/or the energy storage device. For example, a number and/or a pattern of distribution of the first protrusions 58 on the inner surface of the shell layer 52 may depend on a dimension (e.g., a length, a width, and/or a thickness) of the pouch cell housing, and/or a degree of deformation reduction desired in the pouch cell housing. The number and/or pattern of distribution of the first protrusions 58 may be configured to provide a desired reduction in deformation of the pouch housing cell. In some embodiments, a plurality of first protrusions 58 can be uniformly or substantially uniformly spaced from one another across the inner surface 54 of the shell layer 52. In some embodiments, the plurality of first protrusions 58 can be non-uniformly spaced from one another across the inner surface 54. In some embodiments, the plurality of first protrusions 58 may be distributed around a center portion of the shell layer 52. In some embodiments, the plurality of first protrusions 58 can be distributed along a diagonal of the shell layer 52.

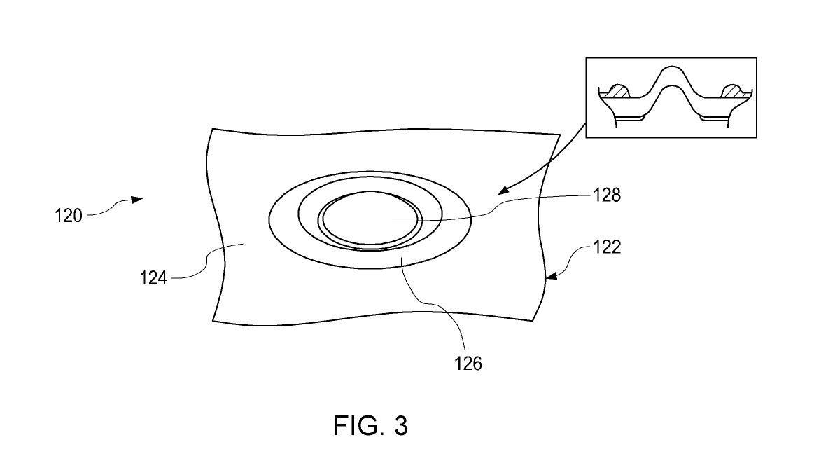

FIG. 3 is an isometric view of an example pouch cell housing shell portion 120 comprising an exposed protrusion 128 on a first surface 122 of the shell portion 120. For example, the first surface 122 may comprise an inner surface of the pouch cell housing such that the exposed protrusion 128 extends into an inner space of a pouch cell housing. As shown in FIG. 3, a first polymer layer 124 on the first surface 122 may have an opening adjacent to the exposed protrusion 128 such that the exposed protrusion 128 extends through the opening, the first polymer layer 124 forming a first elevated polymer ring 126 around the protrusion 128.

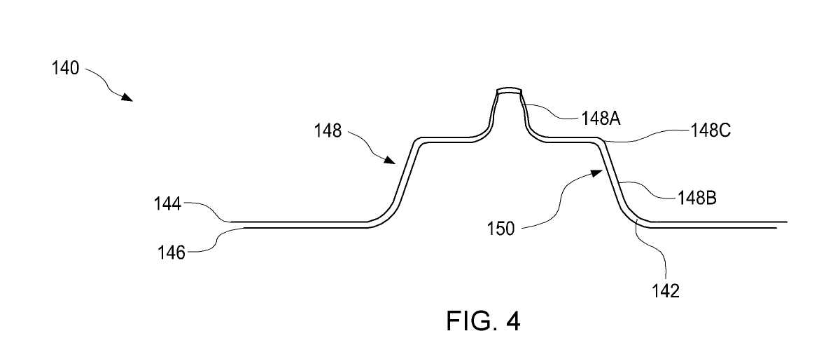

FIG. 4 shows a side cross-sectional view of an example profile of a protrusion 148 which may be formed on an inner surface 144 of a shell layer 142 of a pouch cell housing shell portion 140. For example, the pouch cell housing shell portion 140 may form a part of a pouch cell housing, such as the pouch cell housing 10 of FIG. 1. The inner surface 144 of the pouch cell housing shell layer 142 can face an interior of the pouch cell housing. A depression 150 corresponding to the protrusion 148 can be formed on an outer surface 146 of the shell layer 142. For example, the outer surface 146 may be a surface on an exterior of the pouch cell housing. The protrusion 148 can have a substantially non-continuously tapered profile. For example, the protrusion 148 may have a profile comprising a protrusion step portion 148C. For example, the protrusion 148 can have a protrusion tip portion 148A to one side of a protrusion step portion 148C, and a protrusion base portion 148B to a second side of the protrusion step portion 148C.

The tip portion 148A can have a dimension, a shape and/or a profile distinct from a dimension, a shape and/or a profile of a protrusion base portion 148B. For example, the protrusion tip portion 148A may have a taper similar to or the same as a taper of the first protrusion base portion 148B. In some embodiments, the protrusion tip portion 148A may have a dimension (e.g., a diameter and/or a length) significantly smaller than a diameter of the protrusion base portion 148B. In some embodiments, the protrusion tip portion 148A may have a height and/or a shape similar to a height and/or a shape of the protrusion base portion 148B.

For example, a dimension, a shape, and/or a profile of the protrusion tip portion 148A and/or the protrusion base portion 148B may be configured to provide a desired reduction in a deformation of the pouch cell housing. In some embodiments, the protrusion base portion 148B may have a taper different from a taper of the protrusion tip portion 148A. In some embodiments, the protrusion tip portion 148A can have a shape, and/or a height different from that of the protrusion base portion 148B. In some embodiments, the protrusion tip portion 148A and/or the protrusion base portion 148B can have one or more diameters, degrees of taper, and/or shapes. In some embodiments, the protrusion 148 can have more than one step portions 148C.

In some embodiments, a protrusion tip portion can be configured to facilitate control in a final height of the protrusion such as a height of the protrusion after the protrusion has been attached to a corresponding protrusion on an opposing pouch housing shell layer. For example, the protrusion tip portion 148A may have a cross-sectional dimension significantly smaller than that of the protrusion base portion 148B, as shown in FIG. 4. In some embodiments, the protrusion tip portion can have a cross-sectional dimension to facilitate a collapsing of the protrusion tip portion when the protrusion tip portion is attached to a corresponding protrusion. For example, the significantly smaller cross-sectional dimension may facilitate the collapse of the protrusion tip portion, while the protrusion base portion remains un-collapsed.

In some embodiments, a pouch cell housing having a relatively greater height may comprise a protrusion having a tapered step profile formed on a shell layer of the housing (e.g., protrusion 148 as shown in FIG. 4). Such a tapered step profile may be employed to provide a housing with desired mechanical strength. For example, a relatively thicker pouch cell housing may comprise a protrusion having a tapered step profile on each of two opposing shell layers to provide a housing with desired mechanical strength. In some embodiments, a protrusion for a pouch cell housing having a relatively greater thickness does not have a stepped profile. In some embodiments, a protrusion for a pouch cell housing having a relatively greater thickness does not have a tapered profile. For example, a protrusion for a pouch cell housing having a relatively greater thickness can have a vertical or substantially vertical profile, for example having a cylindrical or substantially cylindrical shape. In some embodiments, a reduced taper in a protrusion profile can facilitate a reduced volume occupied by the protrusion for a given height, for example increasing space available for one or more components of the energy storage device (e.g., one or more electrodes) housed within an interior space of the pouch cell housing.

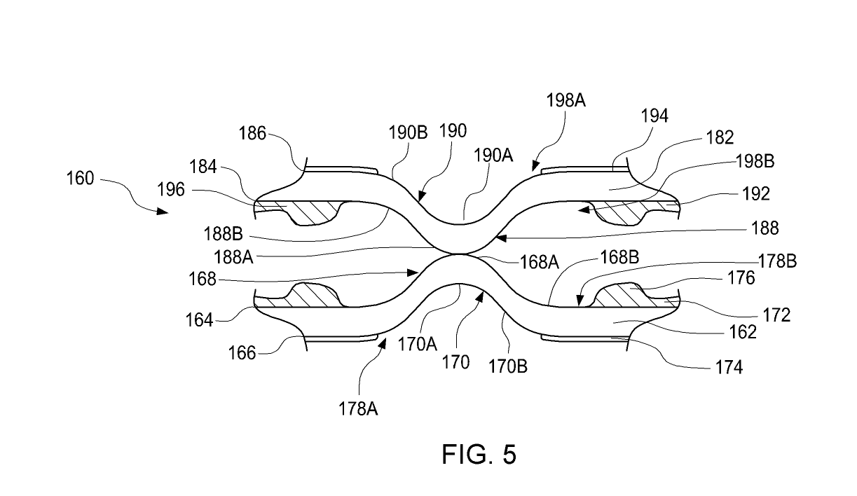

FIG. 5 shows a side cross-sectional view of an example pouch cell housing 160. Pouch cell housing 160 can include a first shell portion with a lower shell layer 162 in contact with an upper shell layer 182 of a second shell portion. Starting from the top, a first polymer layer 194 overlays an upper surface 186 (e.g., a surface on the exterior of the pouch cell housing) of the upper shell layer 182. A downward depression 190 is formed in the upper shell layer 182. The downward depression 190 can have a tip portion 190A and a base portion 190B. The first polymer layer 194 (e.g., a polymer layer comprising a polyamide) can have an opening 198A where the depression 190 is formed. A second polymer layer 192 can be adjacent a lower surface 184 (e.g., a surface on an interior of the pouch cell housing) of the upper shell layer 182. The lower surface 184 may have a downward protrusion 188 corresponding to the downward depression 190 on the upper surface of the upper shell layer 182. The downward protrusion 188 can have a base portion 188B and a tip portion 188A, for example corresponding to the base portion 190B and tip portion 190A of the downward depression 190. The second polymer layer 192 (e.g., a polymer layer comprising a polypropylene) can have an opening 198B surrounding the downward protrusion 188, forming an elevated polymer ring 196 surrounding the downward protrusion base portion 188B.

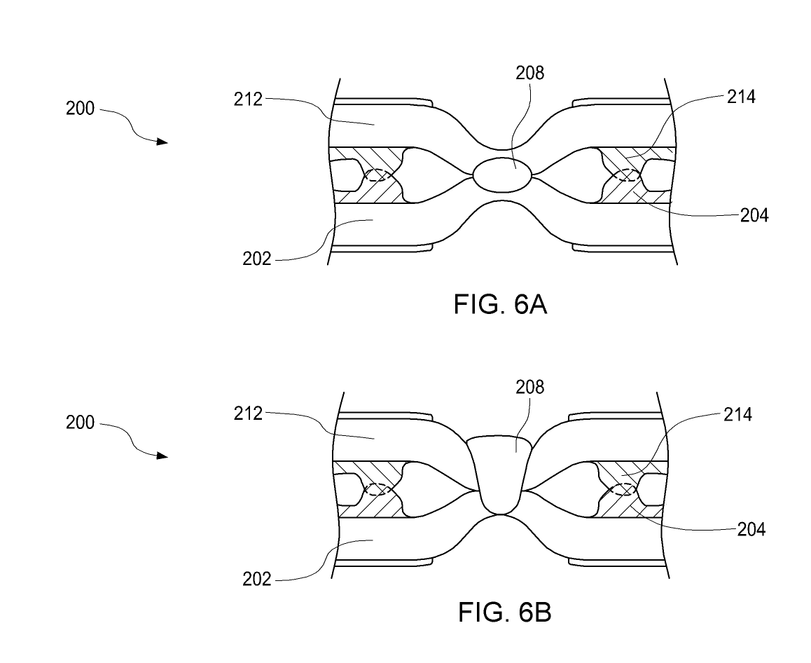

The lower shell layer 162 can have an upward protrusion 168 in an upper surface 164 in contact with the downward protrusion 188 of the upper shell layer 182, the upward protrusion 168 having a tip portion 168A and a base portion 168B. The downward protrusion 188 can be bonded to the upward protrusion 168, for example at the respective tip portions of the two protrusions, coupling the upper shell layer 182 to the lower shell layer 162. A third polymer layer 172 (e.g., a polymer layer comprising a polypropylene) can be adjacent the upper surface 164 (e.g., a surface on an interior of the pouch cell housing) of the lower shell layer 162. In the example embodiment shown in FIG. 5, the third polymer layer 172 can include an opening 178B surrounding the base portion 168B, forming an elevated polymer ring 176 around the base portion 168B. The polymer rings 176, 196 can be sufficiently large to allow them to contact each other, as shown, for example in FIGS. 6A and 6B, and in some embodiments, seal with one another, when the protrusions 168, 188 are in contact with each other. In some embodiments, a bonding of the protrusions 188, 168 to one another can facilitate bonding of the elevated polymer ring 196 with the elevated polymer ring 176 and forming of a seal between the polymer layers 172, 192, providing a sealed barrier (e.g., a sealed barrier comprising a polypropylene) between contents of the energy storage device (e.g., an electrolyte) and interior surfaces 184, 164 of the pouch cell housing shell layers 162, 182. For example, the barrier can prevent a device electrolyte from contacting the exposed bond (e.g., weld) formed between exposed protrusions 188, 168 of the opposing shell layers 162, 182.

In the example pouch cell housing 160 shown in FIG. 5, a lower shell layer 162 can have an upward depression 170 on a lower surface 166 (e.g., a surfacing facing an exterior of the pouch cell housing), the depression 170 corresponding to the upward protrusion 168 on the upper surface 164 of the lower shell layer 162. The depression 170 can have a tip portion 170A and a base portion 170B. A fourth polymer layer 174 (e.g. a polymer layer comprising a polyamide) can overlay the lower surface 166 of the lower shell layer 162. As shown in FIG. 5, the fourth polymer layer 174 can have an opening 178A adjacent the upward depression 170.

In some embodiments, the pouch cell housing can include a protrusion at a location on an upper shell layer which does not correspond to the location of a protrusion on a lower shell layer, the tip portions of the protrusions being coupled to a planar portion of the opposing shell layer. In some embodiments, the pouch cell housing can include opposing shell layers each having a plurality of corresponding protrusions on a surface facing an interior of the housing. The shell layers may be coupled to one another at least in part by bonding to one another the respective tip portions of the corresponding protrusions on the shell layers. In some embodiments, one or both of the opposing shell layers can have a plurality of depressions on an exterior surface, the depressions corresponding to the plurality of protrusions on the interior surfaces of the shell layers. In some embodiments, the plurality of protrusions on the opposing shell layers may not correspond to one another, the tip portions of the protrusions being coupled to a planar portion of the opposing shell layer. As described herein, the protrusions can have a dimension, a shape, a profile and/or a pattern of distribution across a surface of the pouch housing to provide desired reduction of a swelling in the pouch cell housing 160. The dimension, shape, profile and/or pattern of distribution of one or more protrusions on one shell layer may or may not differ from that of one or more protrusions on an opposing shell layer.

In some embodiments, either one of opposing shell layers of a pouch cell housing has no depressions and no protrusions. For example, the pouch cell housing may include one shell layer having one or more protrusions on an interior surface, and the opposing shell layer having no corresponding protrusions, a tip portion of the protrusions on the one shell layer attaching to a planar interior surface of the opposing shell layer.

Referring to FIGS. 6A and 6B, a process for attaching an upper shell layer 212 to an opposing lower shell layer 202 of a pouch cell housing 200 may include a heating process. For example, the lower shell layer 202 and the upper shell layer 212 may be heated to facilitate physical attachment or bonding between the lower and the upper shell layers 202, 212. In some embodiments, a process for attaching the lower shell layer 202 to the upper shell layer 212 can include heating a point of attachment 208. For example, respective tip portions of corresponding protrusions on the lower shell layer 202 and the upper shell layer 212 may be heated to a temperature at or above which a temperature at the portions of the upper and lower shell layers 202, 212 in contact with one another melt. The process for attaching the lower shell layer 202 to the upper shell layer 212 may include a welding process, such as a resistance welding process, and/or an energy beam welding process (e.g., laser welding). FIG. 6A shows a cross-sectional view of an example in which the lower shell layer 202 of the pouch cell housing 200 is attached to the upper shell layer 212 of the pouch cell housing 200 through a process comprising resistance welding. FIG. 6B shows a cross-sectional view of an example in which the lower shell layer 202 of the pouch cell housing 200 is attached to the upper shell layer 212 of the pouch cell housing 200 through a process comprising laser welding. In the examples shown, an attachment process including a resistance welding step may create a more localized attachment point 208 than an attachment point 208 formed from an attachment process including a laser welding step. Other methods to bond the lower shell layer 202 to the upper shell layer 212 may also be suitable, including but not limited to other welding techniques (e.g., ultrasonic welding).

As shown in the side cross-sectional views of FIGS. 6A and 6B, attachment of corresponding protrusions on the lower shell layer 202 and the upper shell layer 212 can facilitate formation of a seal between polymer layers 204, 214 lining opposing surfaces of the lower and upper shell layers 202, 212, respectively. For example, a heating step in the protrusion attachment process described herein may facilitate formation of a seal between the polymer layer 204 lining the lower shell layer 202 and the polymer layer 214 lining the upper shell layer 212. For example, the heating step in the protrusion attachment process may also heat the polymer layers 204, 214. In some embodiments, the heating step may raise a temperature of the polymer layers 204, 214 proximate or adjacent to the attachment point 208 to or above a temperature at which the polymer layers 204, 214 begin to melt (e.g., at or above melting temperatures of the polymer layers 204, 214), facilitating fusing of the polymer layers 204, 214. A seal between the polymer layers 204, 214 may be formed at points where the polymer layers 204, 214 melt due to the heating, thereby forming a continuous polymer lining adjacent or proximate to the attachment point 208 and lining the opposing surfaces of the lower and the upper shell layers 202, 212. In some embodiments, formation of the seal between the polymer layers 204, 214 may be achieved in a step separate from the attachment of the corresponding protrusions of the shell layers 202, 212 to form the attachment point 208.

A seal formed between the polymer layers 204, 214 around the corresponding protrusions of the shell layers 202, 212 may insulate the attachment point 208 from a content of the pouch cell housing 200. The polymer layers 204, 214 may seal a content of the pouch cell housing 200 from the lower shell layer 202 and the upper shell layer 212, for example providing a protective layer for the lower and upper shell layers 202, 212. In some embodiments, the polymer layer 204 of the lower shell layer 202 may comprise polypropylene and the polymer layer 214 of the upper shell layer 204 may comprise polypropylene. For example, polymer layers 204, 214 consisting essentially of polypropylene may form a sealed polymer lining consisting essentially of polypropylene along an interior surface of the pouch cell housing 200, which can prevent or substantially prevent a chemical interaction between a content (e.g., a corrosive content, such as an energy storage device electrolyte) of the pouch cell housing 200 and the shell layers 202, 212 of the housing 200.

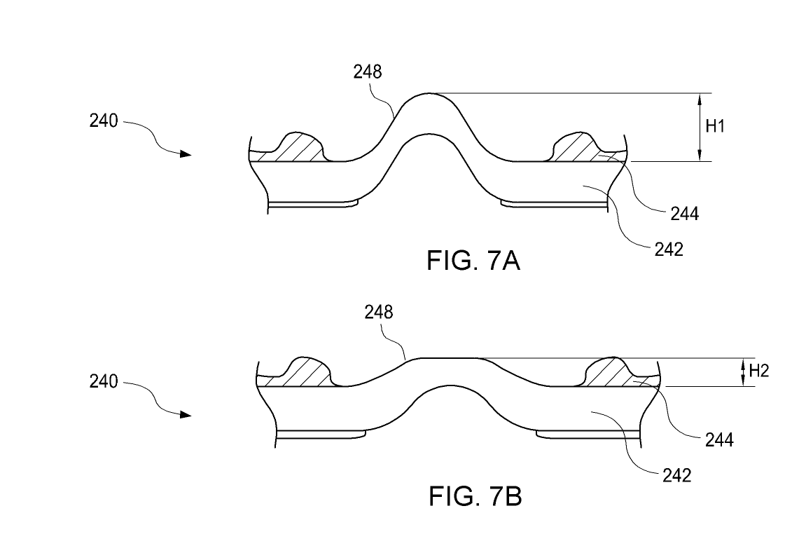

FIG. 7A shows a side cross-sectional view of an example protrusion on a pouch cell housing shell portion. FIG. 7B shows a side cross-sectional view of an example protrusion in an off-set configuration on a prismatic pouch cell housing shell portion. As shown, in some embodiments, a height of a protrusion 248 on a shell layer 242 can be reduced to facilitate creation of a seal between the polymer layer 244 lining the shell layer 242 and a corresponding polymer layer (not shown) of an opposing shell layer (not shown) such that a continuous or substantially continuous lining for interior surfaces of opposing pouch cell shell layers can be formed. As shown in FIGS. 7A and 7B, a height of the protrusion 248 can be reduced from a height of H1 to H2, or that the protrusion 248 may be collapsed from a height H1 to a height H2, to facilitate contact between the polymer layer 244 and a corresponding polymer layer of an opposing shell layer such that a seal may be formed between the polymer layers, as described above with reference to FIG. 6A and 6B. In some embodiments, a height of one or both corresponding protrusions on opposing shell layers of a pouch cell housing can be reduced to facilitate contact between the polymer layers lining each of the opposing shell layers. For example, the attachment between the first and second protrusions may be formed when the first and second protrusions are in an off-set configuration.

A reduction in a height of a protrusion may depend on a dimension (e.g., a thickness) and/or a composition of the polymer ring formed around the protrusion by the polymer layer. For example, a height of a protrusion can be a reduced to a lesser extent if a relatively thicker polymer ring is formed around the protrusion. In some embodiments, a height of a protrusion can be reduced by about 20% to about 50%, including about 20% to about 40%, about 20% to about 30%, and about 30% to about 50%. The extent to which a height of a protrusion is reduced may be selected to facilitate creation of a seal between the polymer layers lining interior surfaces of opposing shell layers. In some embodiments, a height of a protrusion can be reduced prior to a step in which the protrusion is attached to an opposing shell layer, such as before a welding step for attaching the opposing shell layers. In some embodiments, the height of the protrusion can be collapsed during the attachment (e.g., a welding step) of the protrusion to the opposing shell layer, such as during an attachment of the protrusion to a corresponding protrusion on an opposing shell layer.

In some embodiments, a reduction in a height of corresponding protrusions on opposing shell layers can be equal or similar. In some embodiments, a reduction in a height of corresponding protrusions on opposing shell layers can be significantly different from one another. For example, a height of the first protrusion may be reduced while a height of the second protrusion is not, or vice versa. A reduction in the height of the first protrusion and/or the second protrusion can be configured to provide a final pouch cell housing height which can provide sufficient space to house components of the energy storage device (e.g., a stack of energy storage device electrodes). The reduction in the height of the first and/or second protrusion may be configured to provide a final interior pouch cell housing height sufficient to enclose components (e.g., without squeezing the components, such as electrodes and/or separators) of the energy storage device while minimizing a total volume of the energy storage device, and providing a pouch cell housing of desired mechanical strength.

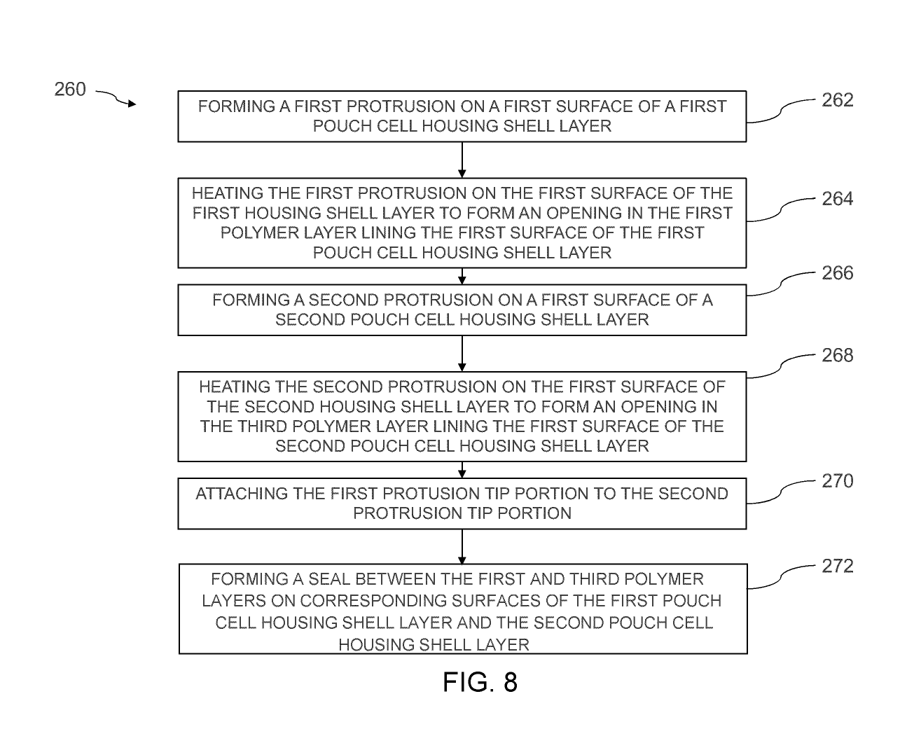

FIG. 8 shows an example process 260 of forming a pouch cell housing. In block 262, the process includes forming a first protrusion on a first surface of a first pouch cell housing shell layer. The first surface of the first pouch cell housing shell layer may be lined with a first polymer player. The first pouch cell housing shell layer can have a second opposing surface. In some embodiments, the second opposing surface of the first pouch cell housing shell layer can be lined with a second polymer layer. In some embodiments, a corresponding depression may be formed on the second opposing surface of the first shell layer in the same step. In block 264, the process can include heating the first protrusion on the first surface of the first housing shell layer. Said heating step can form an opening in the first polymer layer lining the first surface of the first pouch cell housing shell layer. For example, the first protrusion tip portion may be heated. An opening in the first polymer layer can be formed proximate to or adjacent the first protrusion such that the first protrusion extends through the opening formed in the first polymer layer. In some embodiments, an opening can be formed in the second polymer layer lining the second surface of the first shell layer during the same heating process in which the opening in the first polymer layer is formed. For example, an opening in the second polymer layer can be formed proximate to or adjacent the corresponding depression during the same heating process.

In some embodiments, the process 260 of forming a pouch cell housing can include additional steps, such as formation of a protrusion on a second pouch cell housing shell layer. For example, as shown in block 266, the process may include forming a second protrusion on a first surface of a second pouch cell housing shell layer. A corresponding depression may be formed on a second surface of the second shell layer in the same step, such as on a second surface opposite the first surface. The first surface of the second pouch cell housing shell layer may be lined with a third polymer player. The second pouch cell housing shell layer can have a second opposing surface. In some embodiments, the second opposing surface of the second pouch cell housing shell layer can be lined with a fourth polymer layer. In some embodiments, the first and third polymer layers comprise polypropylene, and the second and fourth polymer layers comprise a polyamide.

In block 268, the process includes heating the second protrusion on the first surface of the second housing shell layer to form an opening in the third polymer layer lining the first surface of the second pouch cell housing shell layer. For example, the opening in the third polymer layer can be proximate or adjacent to the second protrusion such that the second protrusion extends through the opening. In some embodiments, an opening can be formed in the fourth polymer layer lining the second surface of the second shell layer during the same heating process in which the opening in the third polymer layer is formed.

In block 270, a tip portion of the first protrusion can be attached or bonded to a tip portion of the second protrusion, attaching the first shell layer to the second shell layer. In block 272, a seal may be formed between the first and third polymer layers on corresponding surfaces of the first shell layer and the second shell layer which face one another. For example, the seal may insulate the first and the second shell layers from a content of the pouch cell housing (e.g., an electrolyte), including insulating portions of the shell layers forming the attachment point.

As described herein, one or more energy storage device components housed within a pouch cell housing may include one or more openings to facilitate contact between a first protrusion on a first shell layer and an opposing second shell layer. In some embodiments, an energy storage device component housed within a pouch cell housing can have one or more openings extending through an entire thickness of the component to facilitate contact between corresponding protrusions on opposing shell layers of the pouch cell housing (e.g., an opening to facilitate attachment between protrusion 188 on upper shell layer 182 and protrusion 168 on lower shell layer 162, as shown in FIG. 5). For example, an energy storage device component stack housed within a pouch cell housing can include a plurality of energy storage device components, each storage device component having one or more openings, each opening aligning with a corresponding opening on each of the other energy storage device components in the stack such that one or more openings extend through an entire thickness of the energy storage component stack. The one or more openings extending through the entire thickness of the energy storage component stack may facilitate contact between opposing shell layers, including corresponding protrusions on opposing shell layers, of the pouch cell housing.

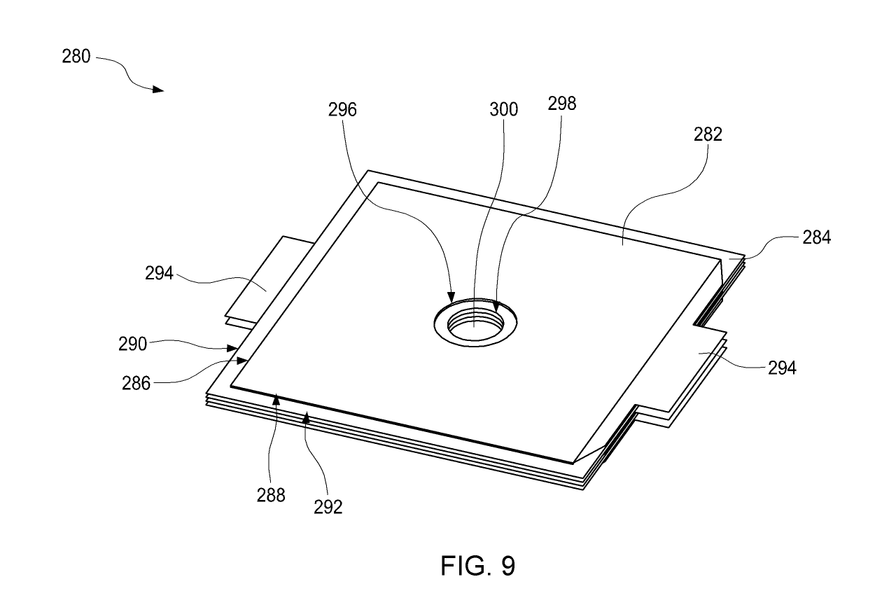

FIG. 9 shows an energy storage device component stack 280 which can be housed within embodiments of the pouch cell housing described herein. The energy storage device component stack 280 can include one or more energy storage device components, including for example, a plurality of energy storage device electrodes 282 and one or more energy storage device separators 284. For example, the energy storage device component stack 280 may include a plurality of energy storage device separators 284 and a plurality of energy storage device electrodes 282 in alternating arrangement (e.g., a first energy storage device electrode being separated from a second energy storage device electrode by an energy storage device separator). In some embodiments, a pouch cell housing can include more than one energy storage device component stack, each energy storage device component stack including one or more energy storage device separators and a plurality of energy storage device electrodes.

The energy storage device separator 284 can be configured to provide electrical separation between two electrodes adjacent to two parallel opposing surfaces of the separator, while permitting ionic communication between the two adjacent electrodes. In some embodiments, an energy storage device separator can comprise a porous electrically insulating material (e.g., an electrically insulating polymeric material, a paper based material), providing electrical insulation while facilitating ionic transport between the two electrodes adjacent to the separator.

The energy storage device electrode 282 can include a current collector configured to facilitate an electrical coupling between the electrode and an external circuit. The current collector can comprise a conductive material, including for example a metallic material (e.g., aluminum, copper, gold, platinum, palladium, and/or alloys of the metals), and having any suitable shape and/or suitable dimension (e.g., a width, a length, and/or a thickness). For example, the current collector may have a rectangular or substantially rectangular shape (e.g., a rectangular shaped aluminum foil), such that the electrode may have a rectangular or substantially rectangular shape. In some embodiments, suitable current collectors may have a thickness of about 20 microns to about 100 microns, including about 30 microns to about 50 microns, and including for example about 40 microns. A variety of thicknesses may be suitable. In some embodiments, an electrode can have one or more electrode films over one or more surfaces of the current collector. For example, a current collector having a rectangular foil configuration may have one or more electrode films over one or both of two parallel opposing surfaces.

The electrode 282 can include an extension 294 to facilitate electrical connection between the electrode 282 and an external circuit. For example, the electrode 282 can have a current collector including the extension 294 for facilitating electrical contact with an external circuit. The extension 294 can have a variety of configurations (e.g., a shape and/or a dimension) suitable for providing desired electrical connection with the external circuit. For example, the extension 294 may be electrically coupled to a positive electrode contact (e.g., the positive electrode contact 26 of FIG. 1) or a negative electrode contact (e.g., the negative electrode contact 28 of FIG. 1) for providing electrical connection with the external circuit.

In some embodiments, an electrode can have one or more electrode films on two opposing surfaces of the current collector. In some embodiments, an electrode film can include an active material component. In some embodiments, the active material component is a porous material (e.g., a porous carbon material, such as particles of activated carbon) having a porosity to facilitate an energy storage device performance. Suitable electrode films can also include a binder component and/or an additive component, for example to provide structural support and/or added electrical conductivity for the electrode. Composition of an electrode film may be configured to enable a desired energy storage performance.

An electrode and a separator may have a variety of suitable shapes. Referring to FIG. 9, the electrode 282 and the separator 284 may each have a rectangular shape. Of course, the electrode 282 and the separator 284 may have other suitable shapes, including for example a circular shape. In some embodiments, the electrode 282 can have a similar shape or a different shape from a shape of the separator 284.

The one or more electrodes 282 can each have an opening 296 at a center portion or substantially a center portion of the electrode 282, and the adjacent separator 284 has an opening 298 at a center portion or substantially a center portion of the separator 284. In this embodiment, the opening 296 in the electrode 282 and opening 298 in the separator 284 align to provide an opening 300 for facilitating contact between opposing shell layers of a pouch cell housing (e.g., an upper shell layer 182 and an opposing lower shell layer 162 of a pouch cell housing 160, as shown in FIG. 5). For example, a portion of one or both of corresponding opposing protrusions on opposing shell layers can extend into at least a portion of the opening 300 such that the opposing protrusions can contact one another. In some embodiments, at least a portion of corresponding protrusions on opposing shell layers can extend into the opening 300 and contact one another within the opening 300. It will be understood that openings 296, 298, and 300 are generally positioned anywhere on electrodes 282 suitable to allow a protrusion to extend therethrough, and need not be centered within each of the one or more electrodes 282.

In some embodiments, an electrode and a separator each can include a plurality of openings 296, 298. For example, the plurality of openings in each electrode of an assembled energy storage device component stack can align with the plurality of openings in each separator of the assembled energy storage device component stack, providing a plurality of openings which extend through an entire thickness of the assembled energy storage device component stack. The plurality of openings of the energy storage device component stack can facilitate contact between a corresponding plurality of protrusions on a first shell layer and/or a second opposing shell layer, for example, including a plurality of opposing protrusions on the second opposing shell layer. For example, at least a portion of each protrusion on the first shell layer can extend into one of the plurality of openings of the energy storage device component stack and contact a corresponding protrusion on the second opposing shell layer within the opening.

The one or more openings in an electrode and the one or more openings in a separator can have a shape corresponding to a shape of a portion of a protrusion extending through the openings in the electrode and the separator. In some embodiments, the one or more openings in the electrode and the one or more openings in the separator can have a similar shape as a shape of a portion of a protrusion extending through the openings. In one embodiment, as shown in FIG. 9, the opening 296 in the electrode 282 and the opening 298 in the separator 284 each has a circular or substantially circular shape, providing an opening 300 having a circular or substantially circular shape such that a portion of a protrusion having a circular or substantially circular shape may extend through the opening 300, facilitating contact between a first protrusion and an opposing shell layer, including a corresponding protrusion on the opposing shell layer. Of course the openings in the electrode and/or separator and the protrusions can have other suitable shapes. In some embodiments, the one or more openings in the electrode and/or the separator may have a shape different from a shape of the portion of the protrusion extending through the opening.

The one or more openings in an electrode and the one or more openings in a separator can each have a dimension sufficiently large for facilitating contact between first protrusions on a shell layer and an opposing shell layer, including corresponding second protrusions on the opposing shell layer. For example, the one or more openings in the electrode and the one or more openings in the separator may have a dimension sufficiently large to provide one or more openings extending through the energy storage device component stack having a sufficiently large dimension to allow a portion of first protrusions on a first shell layer and/or a portion of second opposing protrusions on a second opposing shell layer to extend into the one or more openings extending through the energy storage device component stack, such that the first protrusions may contact the second opposing shall layer. In some embodiments, the openings extending through the energy storage device component stack can have a sufficiently large dimension to facilitate contact between and sealing of one or more polymer layers on the first shell layer and the second opposing shell layer with one another (e.g., polymer layers 172 and 192 on shell layers 162 and 182, respectively, as shown in FIG. 5). The degree to which a dimension of an opening in the electrode and/or separator is larger than a dimension of a portion of a protrusion extending therethrough can be configured to facilitate contact between opposing shell layers, including corresponding protrusions on opposing shell layers, while maximizing an active electrode surface area to provide an energy storage device having desired energy density. In some embodiments, a dimension of the openings in the electrode and/or the separator can be configured to facilitate contact between opposing protrusions while providing a desired electrode surface area for desired energy storage device performance.

In some embodiments, one or more openings in an electrode of an energy storage device component stack can have a dimension larger than a corresponding dimension of the one or more openings in an adjacent separator. For example, a portion of the electrode may extend beyond the adjacent separator and into the opening formed by the openings in the electrode and the adjacent separator. In some embodiments, the one or more openings in the separator can have a reduced dimension relative to the one or more openings in the electrode to facilitate reliable electrical insulation between neighboring electrodes. A difference between a size of one or more openings in an electrode and a size of one or more corresponding openings in an adjacent separator may be configured to facilitate reliable electrical insulation between electrodes adjacent to the separator, while providing an energy storage device having a desired energy density performance (e.g., minimizing an energy storage device weight by reducing an amount of separator material used in the device).

In one embodiment, as shown in FIG. 9, the circular or substantially circular opening 296 in the electrode 282 may have a larger diameter than the circular or substantially circular opening 298 in the adjacent separator 284, such that an edge of the separator 284 defining the opening 298 extends beyond an edge of the electrode 282 defining the opening 296. For example, the edge of the separator 284 defining the opening 298 may define the opening 300 in the energy storage device component stack 280. In the embodiment, the separator 284 extends beyond the electrode 282 within the opening 300 to a uniform or substantially uniform extent along the circumference of the opening 300.

In some embodiments, a separator may have one or more outer edges which extend beyond a corresponding outer edge of an adjacent electrode. In some embodiments, an edge of the separator may extend beyond a corresponding edge of an adjacent electrode by an amount configured to facilitate reliable electrical insulation between electrodes adjacent to the separator, while minimizing an amount of energy storage device separator material, for example to facilitate a desired energy storage device energy density performance by facilitating a reduced energy storage device dimension and/or weight.

In some embodiments, as shown in FIG. 9, the separator 284 having a rectangular or substantially rectangular shape is adjacent to an electrode 282 having a rectangular or substantially rectangular shape, a first edge 290 of the separator 284 and a perpendicular second edge 292 of the separator 284 having a length greater than a length of a corresponding first edge 286 and a perpendicular second edge 288, respectively, of an adjacent electrode 282. Referring to FIG. 9, each of four edges of a rectangular separator 284 can have a longer length than each of four corresponding edges of the adjacent electrode 282 such that the separator extends beyond the adjacent electrode 282 along all four edges.

The extent to which a first edge of a separator extends beyond a corresponding first edge of an adjacent electrode may be the same as the extent to which a second edge of the separator extends beyond a corresponding second edge of the electrode. In one embodiment, as shown in FIG. 9, the separator 284 having a rectangular shape may have four outer edges each being longer than a corresponding outer edge of the adjacent rectangular shaped electrode 282 to the same or substantially same degree such that the separator 284 extends beyond the electrode 282 to a uniform or substantially uniform length along all four outer edges of the electrode 282.

In some embodiments, one or more outer edges of a separator may not extend beyond one or more corresponding outer edges of an adjacent electrode. For example, a first edge of a rectangular shaped separator and a perpendicular second edge of the rectangular shaped separator may have the same or substantially the same length as a corresponding first edge and perpendicular second edge, respectively, of an adjacent rectangular shaped electrode.

In some embodiments, a dimension and/or a shape of an opening extending through the energy storage device component stack can vary along a height of the stack. A dimension and/or shape of one or more openings extending through the energy storage device component stack may vary along a height of the openings, for example corresponding to a change in a shape along a height of one or more protrusions extending through the openings. For example, one or more openings in an electrode and/or a separator of the energy storage device component stack may have a different shape and/or dimension from a shape and/or a dimension of corresponding one or more openings in another electrode and/or separator in the energy storage device component stack, respectively. For example, a longest dimension of an opening (e.g., a diameter of a circular opening) in a separator proximate to a base portion of a protrusion extending through the energy storage device component stack may be larger than a longest dimension of an opening in a separator proximate to a tip portion of the protrusion. In some embodiments, a dimension and/or a shape of one or more openings extending through the energy storage device component stack remains the same or substantially the same along the entire thickness of the stack. For example, one or more openings in an electrode and/or a separator of the energy storage device component stack may have a same shape and/or a same dimension as a shape and/or a dimension of corresponding one or more openings in all other electrodes and/or all other separators in the energy storage device component stack, respectively.

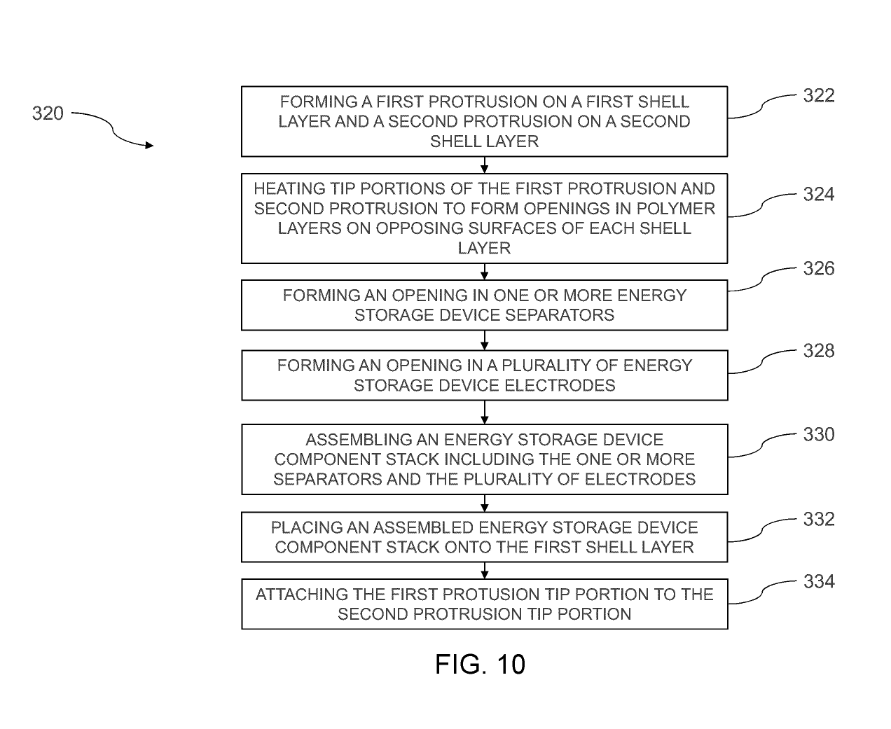

FIG. 10 shows an example process 320 of forming an energy storage device including a pouch cell housing enclosing an energy storage device component stack. In block 322, a first protrusion can be formed on a first shell layer of the pouch cell housing and a second protrusion can be formed on a second shell layer. In some embodiments, a plurality of protrusions can be formed on the first shell layer, and a corresponding plurality of protrusions can be formed on the second shell layer. A method of forming a protrusion on a shell layer can include any of the processes describes herein. In block 324, tip portions of the first protrusion on the first shell layer and the second protrusion on the second shell layer can be heated to form openings in polymer layers on opposing surfaces of each of the first shell layer and the second shell layer. A tip portion of a protrusion can be heated according to any of the processes described herein.

As shown in block 326, the process 320 of forming the energy storage device may also include forming an opening in one or more separators of the energy storage device component stack. The opening in a separator can be created through a variety of suitable methods, including for example a laser cutting technique and/or a mechanical stamping technique. In some embodiments, a plurality of openings can be formed in a separator. In block 328, an opening can be formed in a plurality of electrodes of the energy storage device component stack. The opening in an electrode can be created through a variety of suitable methods, including for example a laser cutting technique and/or a stamping technique. In some embodiments, a plurality of openings can be formed in the plurality of electrodes.

In block 330, the energy storage device component stack including the one or more separators and the plurality of electrodes can be assembled. For example, the energy storage device component stack may be assembled by stacking the one or more separators and the plurality of electrodes one on top of the other. In some embodiments, the storage device component stack can include the one or more separators arranged in alternating order with the plurality of electrodes. For example, an energy storage device component stack may include a separator and two electrodes, the separator being between the two electrodes to electrically insulate an electrode from the other electrode while facilitating ionic communication between the two electrodes. In some embodiments, the one or more openings in the one or more separators can align with the one or more openings in the plurality of electrodes in an assembled energy storage device component stack, providing one or more openings which extend through an entire thickness of the assembled stack.

In block 332, the assembled energy storage device component stack can be placed on the first shell layer, the protrusion on the first shell layer extending into a corresponding opening in the assembled energy storage device component stack. In some embodiments, the first shell layer can include a plurality of protrusions and the assembled energy storage device component stack can include a plurality of openings, such that the plurality of protrusions on the first shell layer extends into corresponding plurality of openings in the assembled energy storage device component stack when the component stack is placed on the first shell layer. In block 334, the second shell layer can be attached to the first shell layer by attaching the first protrusion tip portion to the second protrusion tip portion. In some embodiments, the first and second shell layers can include a plurality of protrusions such that corresponding protrusions on the first and second shell layers can be attached to one another by attaching respective tip portions of the corresponding protrusions. For example, a second shell layer comprising a plurality of protrusions may be placed on an energy storage device component stack comprising a plurality of corresponding openings, and the plurality of protrusions on the second shell layer can extend into the corresponding plurality of openings in the assembled energy storage device component stack such that the protrusions can contact opposing protrusions on a first layer within the openings in the stack.

Attaching tip portions of corresponding protrusions on the first shell layer and the second shell layer can be performed according any of the methods described herein. In some embodiments, a dimension (e.g., a height, width and/or a length) of a pouch cell housing can depend in part on a dimension (e.g., a height, width and/or a length) of one or more energy storage device component stacks enclosed in the pouch cell housing. For example, a pouch cell housing can have a height, width and/or length configured to enclose the energy storage device component stack without or substantially without pinching the energy storage device component stack.

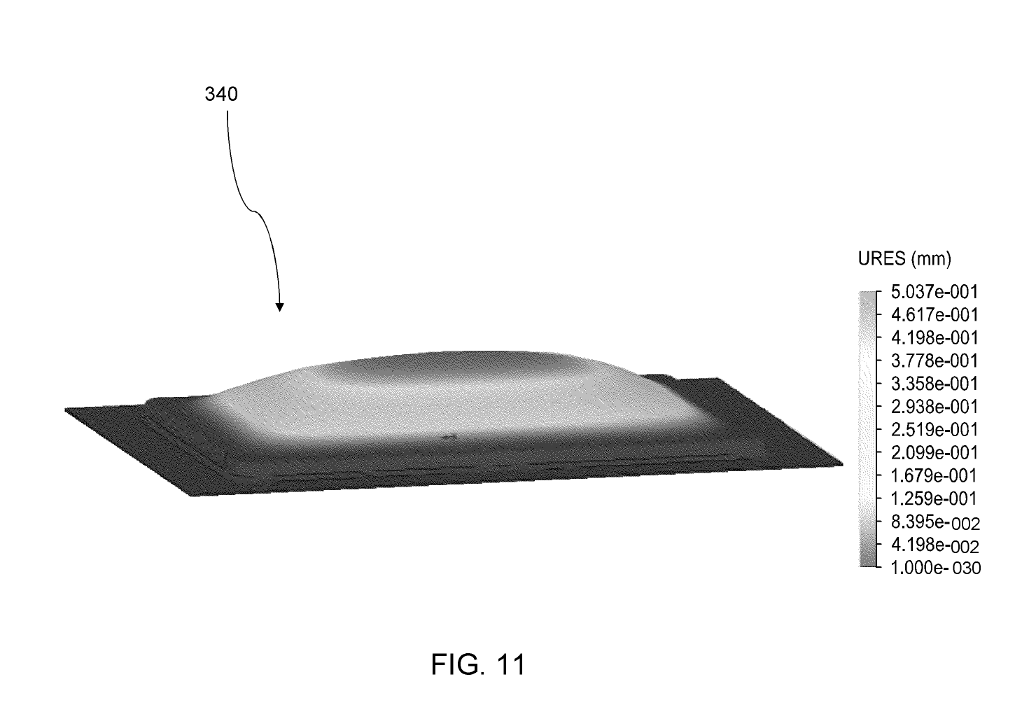

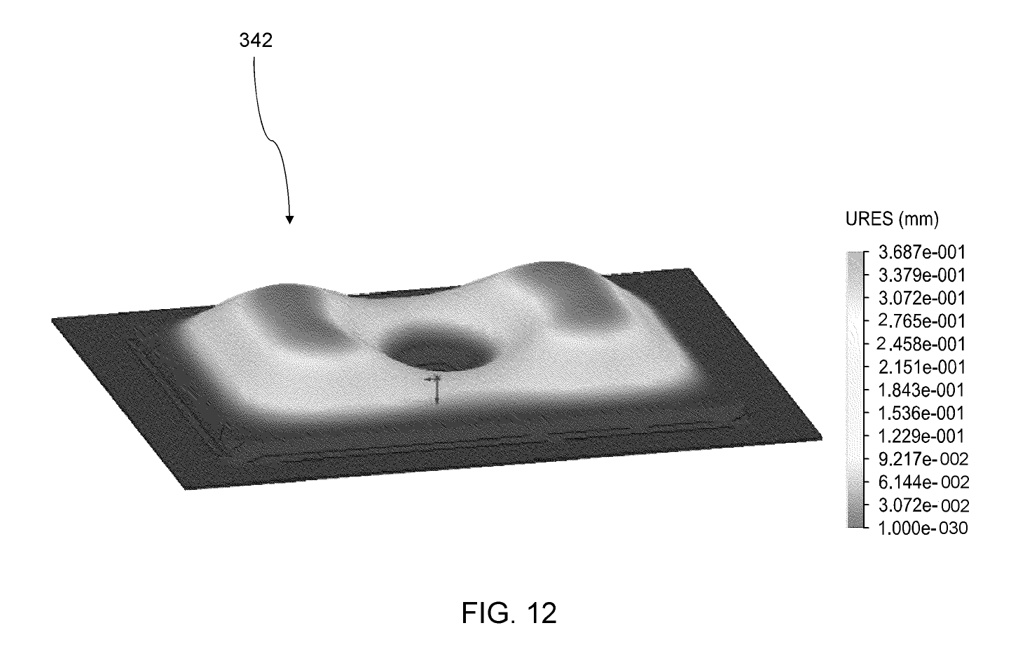

FIG. 11 shows a simulated deformation performance of a pouch cell housing 340 that includes no depressions (e.g., dimples) on an exterior surface and no protrusions on an interior surface configured to reduce a swelling of the pouch cell housing. FIG. 12 shows a simulated deformation performance of a pouch cell housing 342 having a depression on one exterior surface and a corresponding protrusion on one interior surface configured to reduce a swelling of the pouch cell housing 342. For example, the depression or protrusion may have a circular or substantially circular shape, and may be formed at a center or substantially center portion of a shell portion of the pouch cell housing 342. As shown by comparing FIGS. 11 and 12, the pouch cell housing 342 which included the depression, exhibited a reduced degree of swelling as compared to the pouch cell housing 340 without the depression. According to the simulation results shown in FIGS. 11 and 12, a degree of swelling may be reduced by more than about 33% in an embodiment including the depression. A reduction in the degree of swelling can depend on the configuration of the pouch cell housing (e.g., a dimensions of the pouch cell housing and/or a quantity of dimples).

In some embodiments, formation of the one or more openings in a first polymer layer on a first and/or a second pouch cell housing shell layer by heating the shell layer can enable removal of the first polymer layers from a portion of the shell layer without a chemical process (e.g., without use of chemical compounds which may be difficult to dispose of), and/or a mechanical process which can generate by-products that may need an additional disposal process (e.g., a mechanical scraping process to remove the polymer layers, and/or a process including direct heating of the polymers which can produce burnt polymer by-products). In some embodiments, the removal process can provide a protrusion (e.g., a protrusion tip portion) free or substantially free of polymer residue, facilitating the attachment of the protrusion to another shell layer of the pouch cell housing (e.g., to a second protrusion on a second shell layer). In some embodiments, a seal may be formed between first polymer layers of a first shell portion and a second shell portion during an attachment of the first shell portion to the second shell portion. The seal may insulate the shell layers of the pouch cell housing from a content of the housing (e.g., a corrosive component of the energy storage device). Formation of the one or more openings in the first polymer layers by heating the shell layer and providing a seal between the first polymer layers of the shell layers during an attachment process may facilitate a simpler energy storage device fabrication process, providing an energy storage device which can be cheaper to manufacture.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Thus, it is intended that the scope of the invention herein disclosed should not be limited by the particular embodiments described above.

The headings provided herein, if any, are for convenience only and do not necessarily affect the scope or meaning of the devices and methods disclosed herein.

What is claimed is:

1. An energy storage device housing comprising:
a first housing shell portion having a first protrusion on an internal surface of the first housing shell portion; and
a second opposing housing shell portion bonded to at least a portion of the first protrusion.

2. The energy storage device housing of claim 1, wherein the second opposing housing shell portion further comprises a second protrusion on an internal surface of the second opposing housing shell portion.

3. The energy storage device housing of claim 2, wherein the first protrusion is on substantially a center of the first housing shell portion and the second protrusion is on substantially a center of the second opposing housing shell portion.

4. The energy storage device housing of claim 2, wherein the second protrusion comprises a distal tip portion, and wherein the distal tip portion of the second protrusion is bonded to the internal surface of the first housing shell portion.

5. The energy storage device housing of claim 4, wherein the distal tip portion of the second protrusion is bonded to a distal tip portion of the first protrusion.

6. The energy storage device housing of claim 1, further comprising a first polymer lining the internal surface of the first housing shell portion and a second polymer lining an internal surface of the second opposing housing shell portion, and wherein a continuous internal lining comprising the first polymer and the second polymer substantially seals a content of the energy storage device housing.

7. The energy storage device housing of claim 1, further comprising an energy storage device component stack including an opening extending through an entire thickness of the energy storage device component stack, at least a portion of the first protrusion extending into the opening of the energy storage device component stack.

8. The energy storage device housing of claim 7, wherein the energy storage device component stack comprises a plurality of energy storage device electrodes and at least one energy storage device separator.

9. The energy storage device housing of claim 8, wherein the second opposing housing shell portion further comprises a second protrusion on an internal surface of the second opposing housing shell portion, wherein both at least a portion of the first protrusion and at least a portion of the second protrusion extend into the opening in the energy storage device component stack, and wherein the first protrusion and second protrusion are bonded to one another within the opening in the energy storage device component stack.

10. The energy storage device housing of claim 9, wherein the opening in the energy storage device component stack has a similar shape as a shape of the portion of the first protrusion or a shape of the portion of the second protrusion.

11. The energy storage device housing of claim 10, further comprising a first polymer layer lining the internal surface of the first housing shell portion and a second polymer layer lining the internal surface of the second opposing housing shell portion, and wherein the opening in the energy storage device component stack has a dimension configured to accommodate a portion of the first polymer layer and a portion of the second polymer layer.

12. The energy storage device of claim 11, wherein the portion of the first polymer layer and the portion of the second polymer layer each form a polymer ring that seals the first polymer layer with the second polymer layer.

13. The energy storage device housing of claim 1, wherein at least one of the first housing shell portion and the second opposing housing shell portion comprises a stainless steel sheet.

14. A method of forming an energy storage device housing, the method comprising:
forming a first protrusion on a first surface of a first housing shell portion, the first surface being lined with a first polymer; and
heating the first protrusion on the first surface of the first housing shell portion to form an opening in the first polymer adjacent to the first protrusion, wherein the first protrusion extends through the opening in the first polymer.

15. The method of claim 14, further comprising bonding a second opposing housing shell portion to the first surface of the first housing shell portion.

16. The method of claim 15, further comprising forming a second protrusion on a first surface of the second opposing housing shell portion, the first surface of the second opposing housing shell portion being lined with a second polymer.

17. The method of claim 16, wherein at least one of the first polymer and the second polymer consists essentially of polypropylene.

18. The method of claim 16, further comprising heating the second protrusion to form an opening in the second polymer adjacent to the second protrusion, wherein the second protrusion extends through the opening in the second polymer.

19. The method of claim 18, wherein heating the first protrusion comprises heating a distal tip portion of the first protrusion and heating the second protrusion comprises heating a distal tip portion of the second protrusion.

20. The method of claim 19, wherein heating comprises applying a laser heat source.

21. The method of claim 20, wherein heating comprises applying a laser heat source providing electromagnetic radiation having a wavelength less than 10 microns.

22. The method of claim 16, wherein bonding the second opposing housing shell portion to the first surface of the first housing shell portion comprises bonding a distal tip portion of the first protrusion to a distal tip portion of the second protrusion.

23. The method of claim 22, wherein bonding comprises forming an internal housing lining within the energy storage device housing, the internal housing lining comprising the first polymer and the second polymer.

24. The method of claim 23, wherein bonding comprises at least one of laser welding and resistance welding.

25. The method of claim 16, further comprising forming an opening in one or more energy storage device component stacks for facilitating contact between the first protrusion and the second opposing housing shell portion, the opening having a dimension configured to accommodate at least a portion of the first protrusion.

26. The method of claim 25, further comprising placing the energy storage device component stack on the first housing shell portion, a distal tip portion of the first protrusion extending into the opening in the energy storage device component stack.

27. The method of claim 26, further comprising placing the second opposing housing shell portion on the energy storage device component stack, a distal tip portion of the second protrusion extending into the opening in the energy storage device component stack and contacting the distal tip portion of the first protrusion within the opening.
